(19) United States
(12) Patent Application Publication
(10) Pub. No.: US 2004/0219251 A1
(43) Pub. Date: Nov. 4, 2004

(54) Method and apparatus for producing fabric reinforced structural components

(76) Inventors: Ulrich Eberth, Stade (DE); Paul Joern, Hamburg (DE)

Correspondence Address: FASSE PATENT ATTORNEYS, P.A., P.O. BOX 726, HAMPDEN, ME, 04444-0726, US

(21) Appl. No.: 10/836,438

(22) Filed: Apr. 29, 2004

(30) Foreign Application Priority Data
Apr. 30, 2003 (DE) 103 20 791.0

(51) Int. Cl. B29C 47/00; B28B 11/10; B30B 9/28; B28B 3/00; B29D 9/00

(52) U.S. Cl. 425/520; 264/511

(57) ABSTRACT

Fabric reinforced structural components having a predetermined configuration are produced by first assembling a plurality of preforms prepared as semifinished fabric products. Each preform has a configuration that approximates a portion or section of the predetermined configuration of the finished product so that an assembly of the several preforms resembles approximately the predetermined configuration. The assembly is then compacted between two tool sections. The compacted assembly is then impregnated with a matrix forming resin which is then cured. The compacting is performed in a molding tool that includes the two tool sections placed in a flexible vacuum bag that is evacuable. When the compaction is completed the plurality of preforms together have the predetermined configuration of the structural component within a permissible configuration tolerance range.

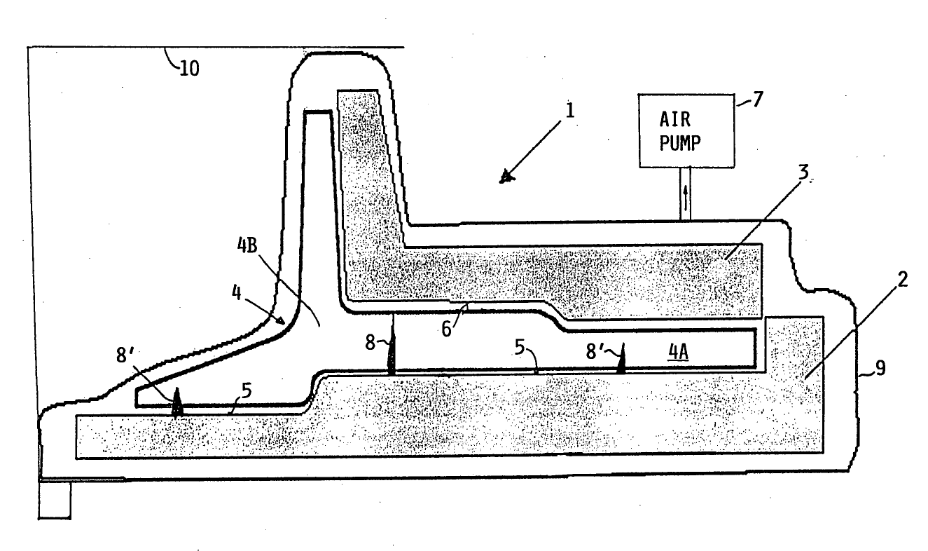

### CROSS-REFERENCE TO RELATED APPLICATION

The present Application is related to U.S. Ser. No. 10/385,287, filed on Mar. 10, 2003, entitled: Method of Producing Textile Preforms for Fiber Reinforced Composite Products From Textile Semi-finished Articles, by inventors Ulrich Eberth et al., Attorney's Docket 4486.

### PRIORITY CLAIM

This application is based on and claims the priority under 35 U.S.C. §119 of German Patent Application 103 20 791.0, filed on Apr. 30, 2003, the entire disclosure of which is incorporated herein by reference.

### FIELD OF THE INVENTION

The invention relates to a method and apparatus for producing fabric reinforced structural components having a predetermined configuration, whereby so-called preforms are used.

### BACKGROUND INFORMATION

The entire disclosure of the above cross-referenced U.S. Ser. No. 10/385,287 is incorporated into the present disclosure. U.S. Ser. No. 10/385,287 discloses the manufacture of so-called preforms.

The term “fabric reinforced” is intended to encompass the connotation of the term fiber reinforced and includes reinforcement materials such as woven textiles, felts, fleeces, knitted and braided materials, and any other materials including fibers suitable for reinforcing a composite material in which the reinforcing materials are embedded in a resin matrix that binds the reinforcing materials by curing the resin. Netting materials are also considered to be within the connotation of the term “fabric materials”.

Semifinished products of fabric materials as outlined above are applied in or on an intermediate carrier. For example, so-called netting can be wound onto a cylindrical carrier body, whereby the netting may be a continuous web. The predetermined configuration or geometry of these carrier bodies serve not only for the preforming or reforming of the semifinished products, but also are used for transporting and storing the semifinished products.

The semifinished products are subsequently further processed by removing the semifinished products from the intermediate carrier followed by further fabrication steps, including the reorientation and reshaping of the fabric or fiber formation into the desired shape of the so-called preform.

The fixation of the so-called preform so that it will retain its configuration may be accomplished with the aid of a binder. These binder systems primarily comprise thermoplastic or thermosetting substances which, for example, are applied as a powder onto the semifinished product. The powders are then activated by the application of heat, whereby the binder maintains the shape of the preform during impregnation and curing.

In addition to securing the fabric or fibers in a desired orientation by the binder systems, the binder systems may also be used to fix the preforms in a compacted state.

The above described preforms are produced so that one preform has approximately the shape of the entire finished product that is to be manufactured by using the respectively shaped single preform. However, the use of such preconfigured preforms in further manufacturing steps is difficult, if not impossible, particularly where the finished product may have complicated configurations and dimensions. Components used in the aircraft manufacturing industry may have such complicated configurations, for example aircraft windows.

### OBJECTS OF THE INVENTION

In view of the foregoing it is the aim of the invention to achieve the following objects:

to solve the above problem in connection with the use of preforms in the manufacture of complicated or complicated and large structural components and/or of structural components having difficult to shape cross-sections;

to use preforms which individually do not have the final predetermined configuration of the finished product; and

to assembly a plurality of individual preforms which together will resemble the predetermined configuration of the finished product even though individually these preforms do not have that configuration.

### SUMMARY OF THE INVENTION

A fabric reinforced product, such as a structural component, having a predetermined configuration is manufactured according to the invention by the combination of the following steps:

a) constructing a plurality of preforms made of semifinished fabric products, each of said preforms having a partial configuration which, when assembled with at least one other preform resembles approximately said predetermined configuration of said fabric reinforced structural component;

b) assembling a plurality of said preforms into a first assembly resembling approximately said predetermined configuration of said structural component;

c) compacting said first assembly of said plurality of preforms to produce a second assembly conforming to said predetermined configuration within a permissible configuration tolerance range; and

d) impregnating said second assembly with a matrix forming resin and curing said resin.

According to the invention there is also provided an apparatus for the simultaneous compacting of a plurality of individual preforms. Said apparatus comprises a first tool section (2) having a first facing contour (5), a second tool section (3) having a second facing contour (6), said first and second facing contours (5, 6) conforming to respective contours of said plurality of preforms of semifinished fabric products and means for applying pressure to said first and second tool sections for compacting and molding a first assembly of said preforms of said semifinished fabric products into a second assembly having said predetermined configuration of a fabric reinforced structural component.

By bringing together a plurality of individual preforms and compacting these preforms together or simultaneously a second assembly of the plurality of preforms is produced in which the several preforms are highly compacted as a unit which approximates the predetermined configuration of the finished product within a permissible configuration tolerance range of the predetermined configuration. Such a preassembled and compacted product can then be impregnated with the matrix forming adhesive resin and cured, preferably at an increased pressure.

The semifinished preforms have individually a contour that matches into the individual contour of other preforms in such a way that the total configuration or contour of a plurality of preforms corresponds to the desired or predetermined configuration of the final product. Preferably the compacting step is performed with a tool permitting a vacuum compacting, preferably under the influence of heat.

It is an advantage of the invention that fabric reinforced structural components having a relatively complicated, finished, predetermined configuration such as aircraft window frames can now be produced of fabric reinforced composite materials which thus permit an optimal utilization of such fabric reinforced composite materials. A cost economy is also achieved because the present window frames can replace conventional aircraft window frames made of forged aluminum sections or components.

### BRIEF DESCRIPTION OF THE DRAWING

In order that the invention may be clearly understood, it will now be described, by way of example, with reference to the single FIGURE of the accompanying drawings showing a sectional view through an assembly of, for example, two preforms positioned between two tool sections.

### DETAILED DESCRIPTION OF A PREFERRED EXAMPLE EMBODIMENT AND OF THE BEST MODE OF THE INVENTION

The FIGURE shows a compacting tool 1 according to the invention. The tool 1 comprises a first tool section 2, for example forming a lower tool section, and a second tool section 3, for example forming an upper tool section. The first tool section 2 has a product facing contour 5 that matches a partial contour of the product to be compacted. The second tool section has a product facing contour 6 that matches another partial contour of the predetermined product configuration. Although only two tool sections are shown in the FIGURE, the tool according to the invention may have more than two tool sections.

As shown in the FIGURE, a first assembly 4 comprising, for example two preforms 4A and 4B is inserted between the tool sections 2 and 3. To make sure that the initial contour of the first assembly 4 is so located between the first and second tool sections that the contour of the first assembly 4 matches the contours 5 and 6 of the tool sections 2 and 3, at least one so-called centering pin 8 is positioned to locate the assembly 4 in the proper position relative to the facing contours 5 and 6 of the tool sections 2 and 3, respectively. Preferably, more than one centering pin is used as shown at 8′. These center pins locate the first assembly 4 in such a way that a distortion of the initial contours of the assembly 4 is avoided. The following compaction produces a second assembly having a contour that closely resembles the predetermined finished contour of the product.

In order to apply a compacting pressure, the tool sections 2 and 3 with the assembly 4 inserted therebetween is inserted into a so-called vacuum bag 9. The bag 9 is closed airtight and evacuated by a conventional air pump 7, whereby the required pressure is applied to the assembly 4 through the tool sections 2 and 3. Preferably, the compaction step is performed simultaneously with the application of heat. For this purpose the tool 1 with the assembly 4 inside the tool or between the tool sections 2, 3 and the whole bag 9 are inserted into a heater 10 merely shown symbolically because such heaters are conventional. Any other source of heat may be used for the present purposes.

The reduced pressure generated inside the vacuum bag 9 produces sufficient compression forces on the two tool sections 2 and 3 to provide the final compacting and the interconnection of the preforms 4A and 4B to form the second assembly 4 that results from the compaction. The second assembly has the required predetermined spatial configuration of the structural component to be produced.

When the compaction is completed, the bag 9 with its content is removed from the source of heat 10 and the tool sections 2 and 3 are removed from the second assembly 4 which is then impregnated with the matrix forming adhesive resin which is then cured, preferably under an increased temperature as well as an increased pressure compared to the pressure that is sufficient for compaction.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A method for producing a fabric reinforced structural component having a predetermined configuration, said method comprising the following steps:
a) constructing preforms made of semifinished fabric products, each of said preforms having a partial configuration which, when assembled with at least one other preform, resembles approximately said predetermined configuration of said fabric reinforced structural component;
b) assembling a plurality of said preforms into a first assembly resembling approximately said structural component;
c) compacting said first assembly of said plurality of preforms to produce a second assembly conforming to said predetermined configuration within a permissible configuration tolerance range; and
d) impregnating said second assembly with a matrix forming resin and curing said resin.

2. The method of claim 1, further comprising preparing said semifinished fabric products by adapting said partial configurations to each other and to said predetermined configuration so that said partial configurations fit together to make up said predetermined configuration when said steps b), c), and d) are completed.

3. The method of claim 1, comprising the following further steps: performing said compacting step by positioning said first assembly of said plurality of preforms on a first tool section, placing a second tool section on said first assembly so that said first assembly is held between said first and second tool sections, and performing said compacting step on said first assembly as a compaction under vacuum while applying heat to produce said second assembly.

4. The method of claim 3, further comprising the step of placing said first tool section, said second tool section and said first assembly therebetween into an evacuable bag and evacuating said evacuable bag to perform said compacting step while applying heat.

5. The method of claim 1, further comprising performing, prior to said assembling a step of draping said preforms onto a carrier having a contour approximating said predetermined configuration to orient fibers in said preform of semifinished fabric products.

6. An apparatus for compacting an assembly of a plurality of preforms of semifinished fabric products, said apparatus comprising a first tool section (2) having a first facing contour (5), a second tool section (3) having a second facing contour (6), said first and second facing contours (5, 6) conforming to respective contours of said plurality of preforms of semifinished fabric products and means for applying pressure to said first and second tool sections for compacting and molding a first assembly of said preforms of said semifinished fabric products into a second assembly having said predetermined configuration of a fabric reinforced structural component.

7. The apparatus of claim 6, wherein said first facing contour (5) and said second facing contour (6) together conform to said predetermined configuration of said fabric reinforced structural component.

8. The apparatus of claim 6, wherein at least one of said first and second tool sections comprises at least one centering pin (8) for locating a respective preform of said semifinished fabric products in a fixed position relative to said first and second tool sections.

9. The apparatus of claim 6, further comprising a flexible vacuum bag enclosing an evacuable space for inserting said first and second tool sections with said plurality of preforms of said semifinished fabric products located between said first and second tool sections, into said evacuable space, and an evacuating pump operatively connected to said vacuum bag for evacuating said evacuable space to thereby apply a compacting pressure to said plurality of preforms.

10. The apparatus of claim 9, further comprising a source of heat positioned for heating said plurality of semifinished fabric products in said vacuum bag.
